(19) United States
(12) Patent Application Publication
(10) Pub. No.: US 2010/0109515 A1
(43) Pub. Date: May 6, 2010

(54) OLED WITH METAL COMPLEXES HAVING A HIGH QUANTUM EFFICIENCY

(75) Inventors: Herbert Friedrich Boerner, Aachen (DE); Hans-Peter Loebl, Monschau-Imgenbroich (DE); Josef Salbeck, Kaufungen (DE); Elena Popova, Kassel (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/593,363

(22) PCT Filed: Apr. 4, 2008
(86) PCT No.: PCT/IB08/51274

§ 371 Date: Sep. 28, 2009

(30) Foreign Application Priority Data
Apr. 4, 2007 (EP) 07105616.2

(51) Int. Cl. H01J 1/62

(52) U.S. Cl. 313/504

(57) ABSTRACT

The present invention is directed to the field of organic light emitting diode (OLED) electroluminescent devices comprising a light-emitting layer containing an organic metal coordination compound with tailored ligands of the general structure (1) where (2) is a N-containing heterocycle comprising one or more cycle and where (3) is a unit with a triplet energy of at least 22,220 cm⁻¹.

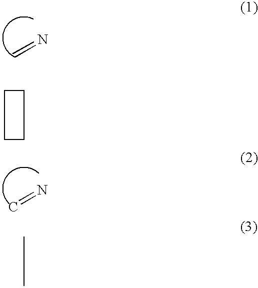

### FIELD OF THE INVENTION

The present invention is directed to the field of organic light emitting diode (OLED) electroluminescent devices comprising a light-emitting layer containing an organic metal coordination compound with tailored ligands having a high triplet energy.

### BACKGROUND OF THE INVENTION

While organic electroluminescent (EL) devices have been known for over two decades, their performance is generally limited due to several adverse effects. In its simplest form, an organic EL device is comprised of an anode for hole injection, a cathode for electron injection, and an organic medium sandwiched between these electrodes to support charge recombination that yields emission of light. These devices are commonly referred to as organic light-emitting diodes (OLEDs).

In ordinary organic EL devices fluorescence caused during a transition of luminescent center molecules from a singlet excited state to a ground state is used as luminescence. However, only 25% of all excitons produced by recombination of carriers comprise singlet excitons in principle. For this reason, when fluorescence caused during the transition from the singlet state to the ground state is utilized a resultant theoretical upper limit for the luminescent efficiency is 25% based on all the produced excitons.

This limit can be overcome by utilizing phosphorescence material. More specifically, in the case of the phosphorescence material excitons produced by recombination of carriers comprise singlet excitons and triplet excitons in a ratio of 1:3. In case of utilizing phosphorescence caused during transition from the triplet excited state the resultant luminescence efficiency is theoretically expected to be three times that of the efficiency of fluorescence material. Thus, a wide range of phosphorescence material has been reported over the past years for the use as light-emitting compound in OLED devices.

However, the above mentioned organic light-emitting materials utilizing phosphorescence have been accompanied by some drawbacks in the field of luminescent deterioration.

In recent years, several metal complex materials have been reported to act as efficient organic light-emitting layer in OLEDs. Examples range from transition metal complexes with conjugated ligand systems like biphenylenes to so called dopants like bis(azinyl)methane boron compounds (see also EP 1 341 242 A2).

As they also act as a charge transport it is desirable to have a high concentration of the metal complex compounds in the light-emitting layer.
In higher concentrations, however, the effect of quenching of the luminescence becomes more apparent as dimers of the metal complex molecules can build more readily or the formation of exciplex or excimer takes place. Like that, for each metal complex compound an optimum concentration can be determined which is a limiting factor not only for the overall luminescence efficiency but also for the life time of the light-emitting layer.

For example, EP 1 191 612 A2 describes a metal coordination compound as a material suitable for an organic layer for luminescence devices having a central metal atom of Ir, Rh or Pd and at least two cyclic ligands containing two or more nitrogen and/or sulfur atoms so that the HOMO/LUMO energy gap is decreased, thus allowing a long wavelength luminescence (orange or red). However, a greater thermal stability of the luminescent compound together with even higher photoluminescence effectiveness is desirable. The term “HOMO” denotes the highest occupied molecular orbital, the term “LUMO” denotes the lowest unoccupied molecular orbital.

### SUMMARY OF THE INVENTION

It is therefore an object of the present invention to provide a device which is able to at least partially overcome some of the above-mentioned drawbacks and helps to increase the efficiency of the light-emitting layer whilst showing good color purity and suitable solubility and thermal stability to be easily applied.

This object is solved by an OLED comprising as a luminescent compound in the light-emitting layer a transition metal complex having at least one tailored ligand having a general structure of

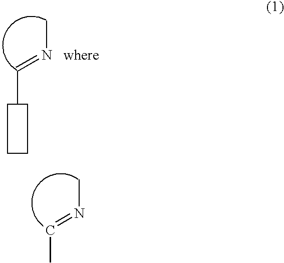

is a N-containing heterocycle comprising one or more cycle and where

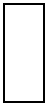

is a unit with a triplet energy of ≧22,220 cm⁻¹.

It has been shown for a wide range of applications within the present invention that by using such complexes the OLED will have an increased efficiency of the light emitting layer without deteriorating the further features of the OLED such as good colour purity and thermal stability—actually for a wide range of applications within the present invention, these other features can even be improved, too.

In a preferred embodiment of the present invention the OLED comprises a metal complex in the luminescent layer where the said one tailored ligand has a combined triplet energy of ≧16,000 cm⁻¹. More preferred the ligand has a combined triplet energy between ≧16,000 cm⁻¹ and ≦19,500 cm⁻¹.

In a preferred embodiment of the present invention the OLED comprises a metal complex in the luminescent layer where the complex has an improved quenching behavior.

According to a preferred embodiment of the present invention, the transition metal complex comprises at least two tailored ligands having a general structure of

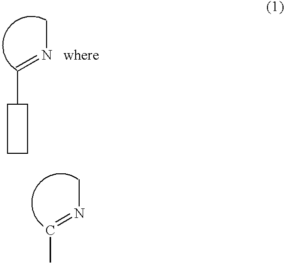

is a N-containing heterocycle comprising one or more cycle and where

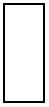

is a unit with a triplet energy of ≧22,220 cm⁻¹.

whereby the ligands are selected independently from each other.

According to a preferred embodiment of the present invention the transition metal complex comprises at least one further ligand selected out of the group

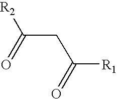

wherein each radical R is independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, silylalkyl, and/or silylalkyloxy,

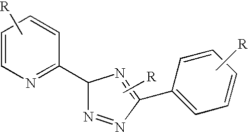

wherein each radical R is independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, silylalkyl, and/or silylalkyloxy,

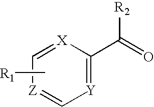

wherein R₁ and/or R₂ are independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether and X, Y and Z are independently selected out of a group comprising C, N, O, S.

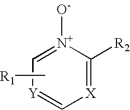

wherein R₁ and/or R₂ are independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether; and X and Y are independently selected out of a group comprising C, N, O, S.

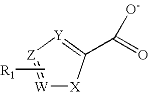

wherein R₁ is selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether,

and W, X, Y and Z are independently selected out of a group comprising C, N, O, S.

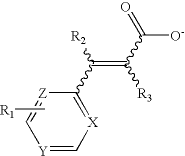

wherein R₁, R₂ and/or R₃ are independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, and X, Y and Z are independently selected out of a group comprising C, N, O, S.

It should be noted that the bonds [symbol] are supposed to indicate that all possible cis/trans isomers are covered by the above structure.

It should be noted that the way of indication and/or notation for R in any of the above structures does not mean or intend that there is only one substituted residue in each of the aromatic rings; rather the formula is to be read as if all possible substitutions (from mono- di- to tetra and/or quinquies substitution) were meant by this notation. This also goes for all further structures mentioned in this application.

In another embodiment of the present invention the metal complex compound comprises a tailored ligand based on a triphenylene or substituted triphenylene structure as shown in formula (2).

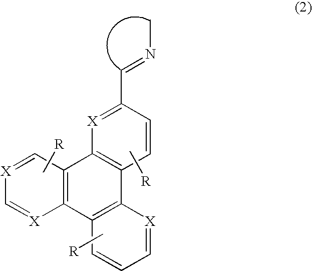

wherein each radical R is independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, silylalkyl, and/or silylalkyloxy,

where every X is independently C or N, and where

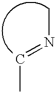

is a N-containing heterocycle comprising one or more cycles.

It should be noted that the way of indication and/or notation for R does not mean or intend that there is only one substituted residue in each of the aromatic rings; rather the formula is to be read as if all possible substitutions (from mono- di- to tetra and/or quinquies substitution) were meant by this notation. This also goes for all further structures mentioned in this application.

Examples for particularly preferred ligands are depicted in the following scheme where the triphenylene ring system can as well be further substituted and/or one or more of the CH-groups of the triphenylene structure can be substituted by N atoms:

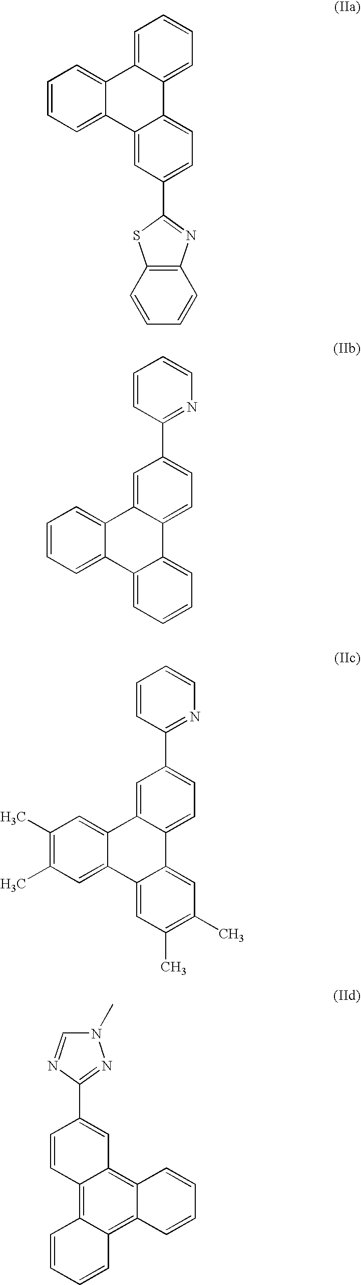

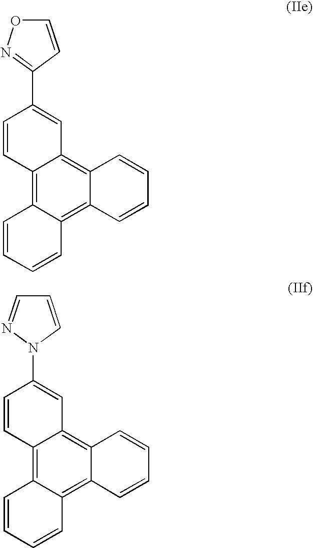

In a further embodiment of the present invention the metal complex compound comprises a tailored ligand based on a structure

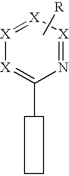

where

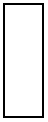

is a unit with a triplet energy of ≧22,220 cm⁻¹ and

wherein each radical R is independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, silylalkyl, and/or silylalkyloxy,

and where every X is independently C or N.

Examples for preferred X—, —N-heterocycles of the embodiment are those who have generally 1, 2, 3, or 4 N atoms, especially preferred 1, 2, or 3 N atoms, and most especially preferred 1 or 2 N atoms.

According to a further embodiment of the present invention the metal complex compound comprises a tailored ligand based on a structure

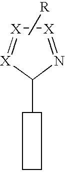

where

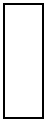

is a unit with a triplet energy of ≧22,220 cm⁻¹ and

wherein each radical R is independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, silylalkyl, and/or silylalkyloxy, and where every X is independently C or N, O and/or S.

Especially preferred the X—, N-heterocycle unit is a pyridyl- or benzothiazyl-cycle or a triazolyl-, an isoxazolyl- or a pyrazolyl-cycle, which can be substituted or not substituted.

Examples for preferred X—, —N-heterocycles of the embodiment are those who have generally 1, 2, 3, or 4 N atoms, especially preferred 1, 2, or 3 N atoms, and most especially preferred 1 or 2 N atoms.

Examples for such five membered heterocyles include the following structures (a), (b), (c), and (d):

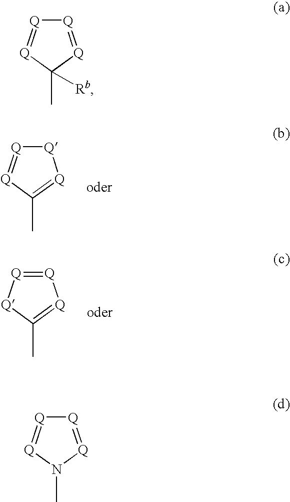

wherein Q can be any CR^{a} or N.

Particularly preferred examples are

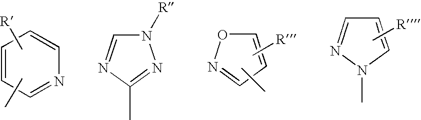

where R′, R″, R′″, and R″″ are defined as stated above for the radicals R.

Advantageously, the OLEDs of the present invention comprising a metal complex compound with at least one tailored ligand having a triplet energy of ≧16,000 cm⁻¹ in the light-emitting layer show an improved photoluminescence efficiency because a higher concentration of the luminescent compound can be incorporated in the light-emitting layer. Quenching of the excited state is reduced by repressing dimer formation. This goal can be achieved on the ground of a greater distance of the metal complex molecules due to the increased size of the ligands. Moreover, the ligands in the metal compounds of the present invention are more rigid which also results in an increased photoluminescence efficiency. Furthermore, the luminescent compounds of the present OLEDs have a high triplet energy whilst having at the same time a high grade of conjugation. Thus, charge transfer can be improved without shift of the emitted wavelength to the non-visible spectra.

Metals which can be used as core metals in the complexes of the present invention are for example B, Al, Si, alkali metals, earth alkali metals, transition metals, such as Fe, Co, Ni, Ru, Rh, Pd, Pt, Os, Ir, Re, Ag, Cu, Au, Hg, Cd, Nb, Zr, Ta. Generally, the metal of the luminescent complex compound of the present invention can preferably be any transition metal. Most preferably, the transition metal of the luminescent compound is selected from the group comprising Ir, Rh, Ru, Pd, and Pt.

### Generic Group Definition:

Throughout the description and claims generic groups have been used, for example alkyl, alkoxy, aryl. Unless otherwise specified the following are preferred groups that may be applied to generic groups found within compounds disclosed herein:

alkyl: linear and branched C1-C8-alkyl,
long-chain alkyl: linear and branched C5-C20 alkyl
alkenyl: C2-C6-alkenyl,
cycloalkyl: C3-C8-cycloalkyl,
alkoxy: C1-C6-alkoxy,
long-chain alkoxy: linear and branched C5-C20 alkoxy
alkylene: selected from the group consisting of:
methylene, 1,1-ethylene, 1,2-ethylene, 1,1-propylidene, 1,2-propylene, 1,3-propylene, 2,2-propylidene, butan-2-ol-1,4-diyl, propan-2-ol-1,3-diyl, 1,4-butylene, cyclohexane-1,1-diyl, cyclohexan-1,2-diyl; cyclohexan-1,3-diyl, cyclohexan-1,4-diyl, cyclopentane-1,1-diyl, cyclopentan-1,2-diyl, and cyclopentan-1,3-diyl,
aryl: selected from homoaromatic compounds having a molecular weight under 300,
arylene: selected from the group consisting of: 1,2-phenylene, 1,3-phenylene, 1,4-phenylene, 1,2-naphtalenylene, 1,3-naphtalenylene, 1,4-naphtalenylene, 2,3-naphtalenylene, 1-hydroxy-2,3-phenylene, 1-hydroxy-2,4-phenylene, 1-hydroxy-2,5-phenylene, and 1-hydroxy-2,6-phenylene,
heteroaryl: selected from the group consisting of: pyridinyl, pyrimidinyl, pyrazinyl, triazolyl, pyridazinyl, 1,3,5-triazinyl, quinolinyl, isoquinolinyl, quinoxalinyl, imidazolyl, pyrazolyl, benzimidazolyl, thiazolyl, benzothiazyl, oxazolidinyl, isoxazylol, pyrrolyl, carbazolyl, indolyl, and isoindolyl, wherein the heteroaryl may be connected to the compound via any atom in the ring of the selected heteroaryl,
heteroarylene: selected from the group consisting of: pyridindiyl, quinolindiyl, pyrazodiyl, pyrazoldiyl, triazolediyl, pyrazindiyl, and imidazolediyl, wherein the heteroarylene acts as a bridge in the compound via any atom in the ring of the selected heteroarylene, more specifically preferred are: pyridin-2,3-diyl, pyridin-2,4-diyl, pyridin-2,5-diyl, pyridin-2,6-diyl, pyridin-3,4-diyl, pyridin-3,5-diyl, quinolin-2,3-diyl, quinolin-2,4-diyl, quinolin-2,8-diyl, isoquinolin-1,3-diyl, isoquinolin-1,4-diyl, pyrazol-1,3-diyl, pyrazol-3,5-diyl, triazole-3,5-diyl, triazole-1,3-diyl, pyrazin-2,5-diyl, and imidazole-2,4-diyl, a —C1-C6-heterocycloalkyl, wherein the heterocycloalkyl of the —C1-C6-heterocycloalkyl is selected from the group consisting of: piperidinyl, piperidine, 1,4-piperazine, tetrahydrothiophene, tetrahydrofuran, 1,4,7-triazacyclononane, 1,4,8,11-tetraazacyclotetradecane, 1,4,7,10,13-pentaazacyclopentadecane, 1,4-diaza-7-thia-cyclononane, 1,4-diaza-7-oxa-cyclononane, 1,4,7,10-tetraazacyclododecane, 1,4-dioxane, 1,4,7-trithia-cyclononane, pyrrolidine, and tetrahydropyran, wherein the heterocycloalkyl may be connected to the —C1-C6-alkyl via any atom in the ring of the selected heterocycloalkyl,
heterocycloalkylene: selected from the group consisting of: piperidin-1,2-ylene, piperidin-2,6-ylene, piperidin-4,4-ylidene, 1,4-piperazin-1,4-ylene, 1,4-piperazin-2,3-ylene, 1,4-piperazin-2,5-ylene, 1,4-piperazin-2,6-ylene, 1,4-piperazin-1,2-ylene, 1,4-piperazin-1,3-ylene, 1,4-piperazin-1,4-ylene, tetrahydrothiophen-2,5-ylene, tetrahydrothiophen-3,4-ylene, tetrahydrothiophen-2,3-ylene, tetrahydrofuran-2,5-ylene, tetrahydrofuran-3,4-ylene, tetrahydrofuran-2,3-ylene, pyrrolidin-2,5-ylene, pyrrolidin-3,4-ylene, pyrrolidin-2,3-ylene, pyrrolidin-1,2-ylene, pyrrolidin-1,3-ylene, pyrrolidin-2,2-ylidene, 1,4,7-triazacyclonon-1,4-ylene, 1,4,7-triazacyclonon-2,3-ylene, 1,4,7-triazacyclonon-2,9-ylene, 1,4,7-triazacyclonon-3,8-ylene, 1,4,7-triazacyclonon-2,2-ylidene, 1,4,8,11-tetraazacyclotetradec-1,4-ylene, 1,4,8,11-tetraazacyclotetradec-1,8-ylene, 1,4,8,11-tetraazacyclotetradec-2,3-ylene, 1,4,8,11-tetraazacyclotetradec-2,5-ylene, 1,4,8,11-tetraazacyclotetradec-1,2-ylene, 1,4,8,11-tetraazacyclotetradec-2,2-ylidene, 1,4,7,10-tetraazacyclododec-1,4-ylene, 1,4,7,10-tetraazacyclododec-1,7-ylene, 1,4,7,10-tetraazacyclododec-1,2-ylene, 1,4,7,10-tetraazacyclododec-2,3-ylene, 1,4,7,10-tetraazacyclododec-2,2-ylidene, 1,4,7,10,13 pentaazacyclopentadec-1,4-ylene, 1,4,7,10,13-pentaazacyclopentadec-1,7-ylene, 1,4,7,10,13-pentaazacyclopentadec-2,3-ylene, 1,4,7,10,13-pentaazacyclopentadec-1,2-ylene, 1,4,7,10,13-pentaazacyclopentadec-2,2-ylidene, 1,4-diaza-7-thia-cyclonon-1,4-ylene, 1,4-diaza-7-thia-cyclonon-1,2-ylene, 1,4-diaza-7thia-cyclonon-2,3-ylene, 1,4-diaza-7-thia-cyclonon-6,8-ylene, 1,4-diaza-7-thia-cyclonon-2,2-ylidene, 1,4-diaza-7-oxacyclonon-1,4-ylene, 1,4-diaza-7-oxa-cyclonon-1,2-ylene, 1,4diaza-7-oxa-cyclonon-2,3-ylene, 1,4-diaza-7-oxa-cyclonon-6,8-ylene, 1,4-diaza-7-oxa-cyclonon-2,2-ylidene, 1,4-dioxan-2,3-ylene, 1,4-dioxan-2,6-ylene, 1,4-dioxan-2,2-ylidene, tetrahydropyran-2,3-ylene, tetrahydropyran-2,6-ylene, tetrahydropyran-2,5-ylene, tetrahydropyran-2,2-ylidene, 1,4,7-trithia-cyclonon-2,3-ylene, 1,4,7-trithia-cyclonon-2,9-ylene, and 1,4,7-trithia-cyclonon-2,2-ylidene,
heterocycloalkyl: selected from the group consisting of: pyrrolinyl, pyrrolidinyl, morpholinyl, piperidinyl, piperazinyl, hexamethylene imine, 1,4-piperazinyl, tetrahydrothiophenyl, tetrahydrofuranyl, 1,4,7-triazacyclononanyl, 1,4,8,11-tetraazacyclotetradecanyl, 1,4,7,10,13-pentaazacyclopentadecanyl, 1,4-diaza-7-thiacyclononanyl, 1,4-diaza-7-oxa-cyclononanyl, 1,4,7,10-tetraazacyclododecanyl, 1,4-dioxanyl, 1,4,7-trithiacyclononanyl, tetrahydropyranyl, and oxazolidinyl, wherein the heterocycloalkyl may be connected to the compound via any atom in the ring of the selected heterocycloalkyl,
amine: the group —N(R)2 wherein each R is independently selected from: hydrogen, C1-C6-alkyl, C1-C6-alkyl-C6H5, and phenyl, wherein when both R are C1-C6-alkyl both R together may form an —NC3 to an —NC5 heterocyclic ring with any remaining alkyl chain forming an alkyl substituent to the heterocyclic ring,
halogen: selected from the group consisting of: F, Cl, Br and I,
halogenalkyl: selected from the group consisting of mono, di, tri-, poly and perhalogenated linear and branched C1-C8-alkyl
pseudohalogen: selected from the group consisting of —CN, —SCN, —OCN, N3, —CNO, —SeCN
sulphonate: the group —S(O)2OR, wherein R is selected from: hydrogen, C1-C6-alkyl, phenyl, C1-C6-alkyl-C6H5, Li, Na, K, Cs, Mg, and Ca,
sulphate: the group —OS(O)2OR, wherein R is selected from: hydrogen; C1-C6-alkyl; phenyl; C1-C6-alkyl-C6H5; Li; Na; K; Cs; Mg; and Ca,
sulphone: the group —S(O)2R, wherein R is selected from: hydrogen, C1-C6-alkyl, phenyl, C1-C6-alkyl-C6H5 and amine (to give sulphonamide) selected from the group: —NR′2, wherein each R′ is independently selected from: hydrogen, C1-C6-alkyl, ClC6-alkyl-C6H5, and phenyl, wherein when both R′ are C1-C6-alkyl both R′ together may form an —NC3 to an —NCS heterocyclic ring with any remaining alkyl chain forming an alkyl substituent to the heterocyclic ring,
carboxylate derivative: the group —C(O)OR, wherein R is selected from: hydrogen, C1-C6-alkyl, phenyl, C1-C6-alkyl-C6H5, Li, Na, K, Cs, Mg, and Ca,
carbonyl derivative: the group —C(O)R, wherein R is selected from: hydrogen, C1-C6-alkyl, phenyl, C1-C6-alkyl-C6H5 and amine (to give amide) selected from the group: —NR′2, wherein each R′ is independently selected from: hydrogen, C1-C6-alkyl, C1-C6-alkyl-C6H5, and phenyl, wherein when both R′ are C1-C6-alkyl both R′ together may form an —NC3 to an —NC5 heterocyclic ring with any remaining alkyl chain forming an alkyl substituent to the heterocyclic ring,
phosphonate: the group —P(O)(OR)2, wherein each R is independently selected from: hydrogen, C1-C6-alkyl, phenyl, C1-C6-alkyl-C6H5, Li, Na, K, Cs, Mg, and Ca,
phosphate: the group —OP(O)(OR)2, wherein each R is independently selected from: hydrogen, C1-C6-alkyl, phenyl, C1-C6-alkyl-C6H5, Li, Na, K, Cs, Mg, and Ca,
phosphine: the group —P(R)2, wherein each R is independently selected from: hydrogen, C1-C6-alkyl, phenyl, and C1-C6-alkyl-C6H5,
phosphine oxide: the group —P(O)R2, wherein R is independently selected from: hydrogen, C1-C6-alkyl, phenyl, and C1-C6-alkyl-C6H5, and amine (to give phosphonamidate) selected from the group: —NR′2, wherein each R′ is independently selected from: hydrogen, C1-C6-alkyl, C1-C6-alkyl-C6H5, and phenyl, wherein when both R′ are C1-C6-alkyl both R′ together may form an —NC3 to an —NC5 heterocyclic ring with any remaining alkyl chain forming an alkyl substituent to the heterocyclic ring.
polyether: chosen from the group comprising —(O—CH2-CH(R))n-OH and —(O—CH2-CH(R))n-H whereby R is independently selected from: hydrogen, alkyl, aryl, halogen and n is from 1 to 250
silylalkyl: the group —SiR3, whereby each R is independently selected from: hydrogen, C1-C6-alkyl, C1-C6-alkyl-C6H5, and phenyl, wherein when both R are C1-C6-alkyl both R together may form an —NC3 to an —NC5 heterocyclic ring with any remaining alkyl chain forming an alkyl substituent to the heterocyclic ring
Silylalkyloxy: the group —OSiR3, whereby each R is independently selected from: hydrogen, C1-C6-alkyl, C1-C6-alkyl-C6H5, and phenyl, wherein when both R are C1-C6-alkyl both R together may form an —NC3 to an —NC5 heterocyclic ring with any remaining alkyl chain forming an alkyl substituent to the heterocyclic ring.

Unless otherwise specified the following are more preferred group restrictions that may be applied to groups found within compounds disclosed herein:

alkyl: linear and branched C1-C6-alkyl,
long-chain alkyl: linear and branched C5-C10 alkyl, preferably linear C6-C8 alkyl
alkenyl: C3-C6-alkenyl,
cycloalkyl: C6-C8-cycloalkyl,
alkoxy: C1-C4-alkoxy,
long-chain alkoxy: linear and branched C5-C10 alkoxy, preferably linear C6-C8 alkoxy
alkylene: selected from the group consisting of: methylene, 1,2-ethylene, 1,3-propylene, butan-2-ol-1,4-diyl, 1,4-butylene, cyclohexane-1,1-diyl, cyclohexan-1,2-diyl, cyclohexan-1,4-diyl, cyclopentane-1,1-diyl, and cyclopentan-1,2-diyl,
aryl: selected from group consisting of: phenyl, biphenyl, naphthalenyl, anthracenyl, and phenanthrenyl,
arylene: selected from the group consisting of: 1,2-phenylene, 1,3-phenylene, 1,4-phenylene, 1,2-naphtalenylene, 1,4-naphtalenylene, 2,3-naphtalenylene and 1-hydroxy-2,6-phenylene,
heteroaryl: selected from the group consisting of:
pyridinyl, pyrimidinyl, quinolinyl, pyrazolyl, triazolyl, isoquinolinyl, imidazolyl, benzothiazyl, isoxazolyl, and oxazolidinyl, wherein the heteroaryl may be connected to the compound via any atom in the ring of the selected heteroaryl, heteroarylene: selected from the group consisting of: pyridin 2,3-diyl, pyridin-2,4-diyl, pyridin-2,6-diyl, pyridin-3,5-diyl, quinolin-2,3-diyl, quinolin-2,4-diyl, isoquinolin-1,3-diyl, isoquinolin-1,4-diyl, pyrazol-3,5-diyl, and imidazole-2,4-diyl,
heterocycloalkyl: selected from the group consisting of:
pyrrolidinyl, morpholinyl, piperidinyl, piperidinyl, 1,4 piperazinyl, tetrahydrofuranyl, 1,4,7-triazacyclononanyl, 1,4,8,11-tetraazacyclotetradecanyl, 1,4,7,10,13-pentaazacyclopentadecanyl, 1,4,7,10-tetraazacyclododecanyl, and piperazinyl, wherein the heterocycloalkyl may be connected to the compound via any atom in the ring of the selected heterocycloalkyl, heterocycloalkylene: selected from the group consisting of:
piperidin-2,6-ylene, piperidin-4,4-ylidene, 1,4-piperazin-1,4-ylene, 1,4-piperazin-2,3-ylene, 1,4-piperazin-2,6-ylene, tetrahydrothiophen-2,5-ylene, tetrahydrothiophen-3,4-ylene, tetrahydrofuran-2,5-ylene, tetrahydrofuran-3,4-ylene, pyrrolidin-2,5-ylene, pyrrolidin-2,2-ylidene, 1,4,7-triazacyclonon-1,4-ylene, 1,4,7-triazacyclonon-2,3-ylene, 1,4,7-triazacyclonon-2,2-ylidene, 1,4,8,11-tetraazacyclotetradec-1,4-ylene, 1,4,8,11-tetraazacyclotetradec-1,8-ylene, 1,4,8,11-tetraazacyclotetradec-2,3-ylene, 1,4,8,11-tetraazacyclotetradec-2,2-ylidene, 1,4,7,10-tetraazacyclododec-1,4-ylene, 1,4,7,10-tetraazacyclododec-1,7-ylene, 1,4,7,10-tetraazacyclododec-2,3-ylene, 1,4,7,10-tetraazacyclododec-2,2-ylidene, 1,4,7,10,13-pentaazacyclopentadec-1,4-ylene, 1,4,7,10,13-pentaazacyclopentadec-1,7-ylene, 1,4-diaza-7-thia-cyclonon-1,4 ylene, 1,4-diaza-7-thia-cyclonon-2,3-ylene, 1,4-diaza-7-thia cyclonon-2,2-ylidene, 1,4-diaza-7-oxa-cyclonon-1,4-ylene, 1,4 diaza-7-oxa-cyclonon-2,3-ylene, 1,4-diaza-7-oxa-cyclonon-2,2-ylidene, 1,4-dioxan-2,6-ylene, 1,4-dioxan-2,2-ylidene, tetrahydropyran-2,6-ylene, tetrahydropyran-2,5-ylene, and tetrahydropyran-2,2-ylidene, a —C1-C6-alkyl-heterocycloalkyl, wherein the heterocycloalkyl of the —C1-C6-heterocycloalkyl is selected from the group consisting of: piperidinyl, 1,4-piperazinyl, tetrahydrofuranyl, 1,4,7-triazacyclononanyl, 1,4,8,11-tetraazacyclotetradecanyl, 1,4,7,10,13-pentaazacyclopentadecanyl, 1,4,7,10-tetraazacyclododecanyl, and pyrrolidinyl, wherein the heterocycloalkyl may be connected to the —C1-C6-alkyl via any atom in the ring of the selected heterocycloalkyl,
amine: the group —N(R)2, wherein each R is independently selected from: hydrogen; C1-C6-alkyl; and benzyl,
halogen: selected from the group consisting of: F and Cl,
sulphonate: the group —S(O)2OR, wherein R is selected from: hydrogen, C1-C6-alkyl, Na, K, Mg, and Ca,
sulphate: the group —OS(O)2OR, wherein R is selected from: hydrogen, C1-C6-alkyl, Na, K, Mg, and Ca,
sulphone: the group —S(O)2R, wherein R is selected from: hydrogen, C1-C6-alkyl, benzyl and amine selected from the group: —NR′2, wherein each R′ is independently selected from: hydrogen, C1-C6-alkyl, and benzyl,
carboxylate derivative: the group —C(O)OR, wherein R is selected from hydrogen, Na, K, Mg, Ca, C1-C6-alkyl, and benzyl,
carbonyl derivative: the group: —C(O)R, wherein R is selected from: hydrogen, C1-C6-alkyl, benzyl and amine selected from the group: —NR′2, wherein each R′ is independently selected from: hydrogen, C1-C6-alkyl, and benzyl,
phosphonate: the group —P(O)(OR)2, wherein each R is independently selected from: hydrogen, C1-C6-alkyl, benzyl, Na, K, Mg, and Ca,
phosphate: the group —OP(O) (OR)2, wherein each R is independently selected from: hydrogen, C1-C6-alkyl, benzyl, Na, K, Mg, and Ca,
phosphine: the group —P(R)2, wherein each R is independently selected from: hydrogen, C1-C6-alkyl, and benzyl,
phosphine oxide: the group —P(O)R2, wherein R is independently selected from: hydrogen, C1-C6-alkyl, benzyl and amine selected from the group: —NR′2, wherein each R′ is independently selected from: hydrogen, C1-C6-alkyl, and benzyl.
polyether: chosen from the group comprising —(O—CH2-CH(R))n-OH and —(O—CH2-CH(R))n—H whereby R is independently selected from: hydrogen, methyl, halogen and n is from 5 to 50, preferably 10 to 25.

Ligands of a general structure shown in formula 2 can be synthesized in several ways. For instance, such ligands can be produced according to the following scheme 1:

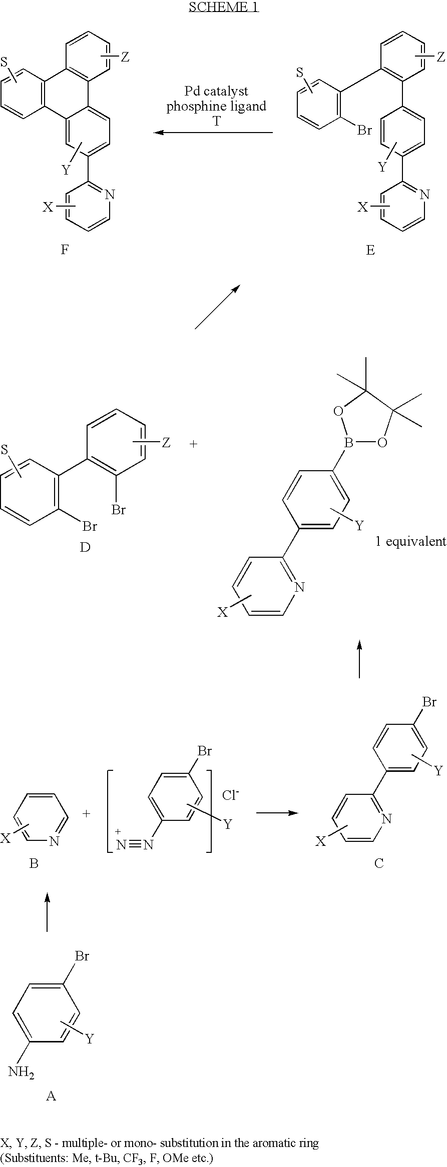

Alternatively, tailored ligands based on the general structure (2) can also be synthesized in accordance to the following scheme:

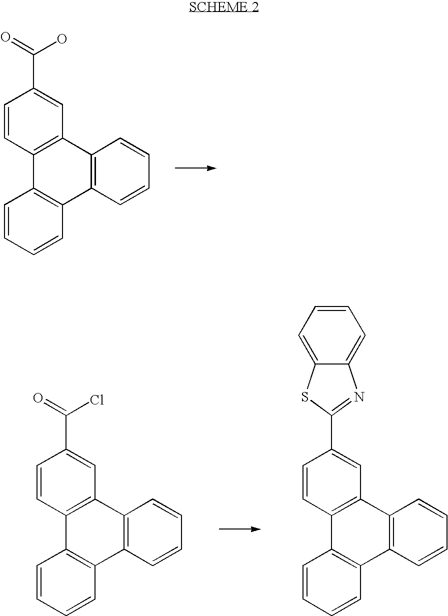

which depicts only one special example and which is not limiting to the ligands of the invention.

Another way to synthesize ligands according to the present invention is shown in the following schemes 3, 4, and 5:

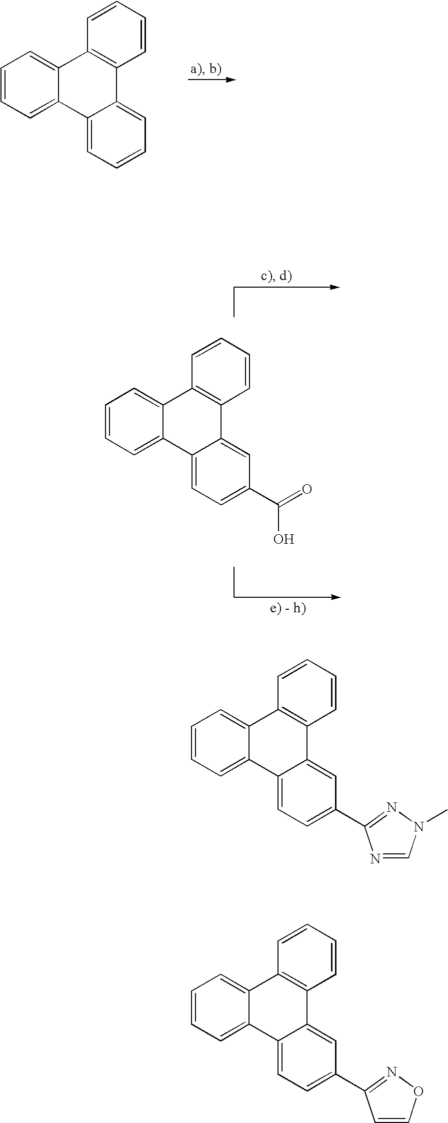

Suitable conditions for the shown reactions are generally know from the literature for analog reactions. Suitable literature for the single in scheme 3 mentioned steps are listed in the following. Specially preferred reaction conditions are also mentioned in the following example parts.
a) and b) analog publication for Dihydropyren: D. M. Connor, S. D. Scott, D. M. Collard, Chr. L. Liotta, D. A. Schiraldi, J. Org. Chem. 1999, 64, 6888-6890.
c) analog publication for 3-Methyl-4-nitrobenzic acid: D. J. Sall, A. E. Arfesten, J. A. Bastian, M. L. Denney, C. S. Harms, J. Med. Chem. 1997, 40, 2843-2857.
d) analog publication for 3-(1-Methyl-1,2,4-triazol-3-yl)-azabicyclo[2.2.2]octane: H. J. Wadsworth, S. M. Jenkins, B. S. Orlek, F. Cassidy, M. S. G. Clark, F. Brown, G. J. Riley, D. Graves, J. Hawkins, Chr. B. Naylor, J. Med. Chem. 1992, 35, 1280-1290.
e) and f) analog publication for Iodbenzic acid: S. E. Gibson et al. Chem. Eur. J. 2005, 11, 69-80.
g) analog publication for Benzaldehyd Oxim: P. Aschwanden et al. Org. Lett. 2005, 7, 5741-5742.
h) analog publication for 3-substituted Isoxazole: A. Baranski, Pol. J. Chem. 1982, 56, 1585-1589 bzw. R. G. Micetich, Can. J. Chem 1970, 48, 467-476 bzw. S.-R. Sheng, X.-L. Liu, Q. Xu, C.-S. Song, Synthesis 2006, 14, 2293-2296.

Scheme 3 is only exemplary. The triphenylene structure can have further substituents or some of the C atoms of the triphenylene structure can be substituted by N atoms.

Another way for the synthesis of examples of inventive ligands stating from a triphenylene structure can lead via the path shown in scheme 4.

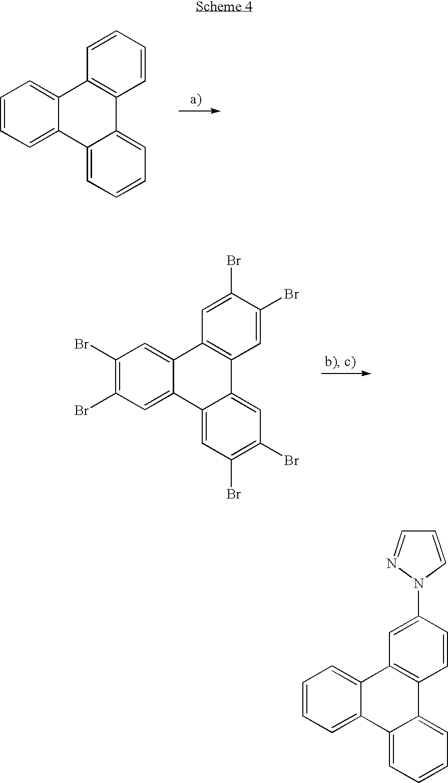

Suitable conditions for the shown reactions are generally know from the literature for analog reactions. Suitable literature for the single in scheme 3 mentioned steps are listed in the following. Specially preferred reaction conditions are also mentioned in the following example parts.
a) analog publication of R. Breslow, Ronald, B. Jaun, Bernhard, R. Q. Kluttz, C.-z. Xia, Tetrahedron 1982, 38, 863-867.
b) analog publication for Phenylpyrazol: J. C. Antilla, J. M. Baskin, T. E. Barder, S. L. Buchwald, J. Org. Chem. 2004, 69, 5578-5587.
c1) analog publication for Dibromchlorbenzol: K. Menzel, L. Dimichele, P. Mills, D. E. Frantz, T. D. Nelson, M. H. Kress, Syn. Lett. 2006, 12, 1948-1952.
c2) analog publication for Tetrabromarylates: G. Dorman, J. D. Olszewski, G. D. Prestwich, Y. Hong, D. G. Ahern, David G, J. Org. Chem. 1995, 60, 2292-2297.
c3) analog publication for Debromining of Aryls: S. Arai, M. Oku, T. Ishida, T. Shioiri; Tetrahedron Lett. 1999, 40, 6785-6790.

Scheme 4 is only exemplary. The triphenylene structure can have further substituents or some of the C atoms of the triphenylene structure can be substituted by N atoms.

Further, the inventive triphenylene derivatives can be synthesized by Arin-Coupling. A general scheme 5 is shown in the following.

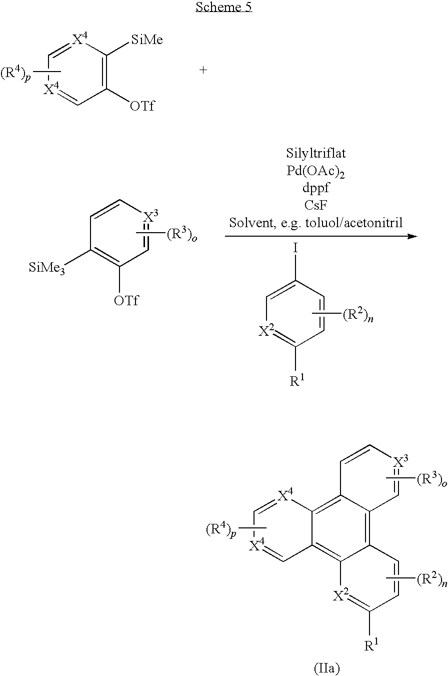

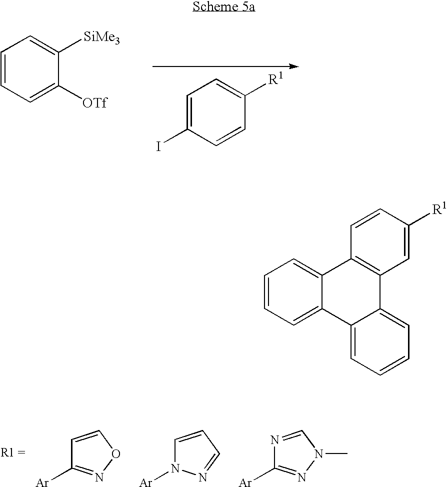

Suitable reaction conditions are analog to the production of methyltriphenylene, like e.g. in Z. Liu, R. Larock, J. Org. Chem. 2007, 72, 223-232 described.

Especially preferred reaction conditions are mentioned in the following examples.

Suitable examples of metal complex compounds which can be used as luminescent components in the light-emitting layer of an OLED according to the invention are shown in the following formulae (3), (4), (5), (6), (7), and (8):

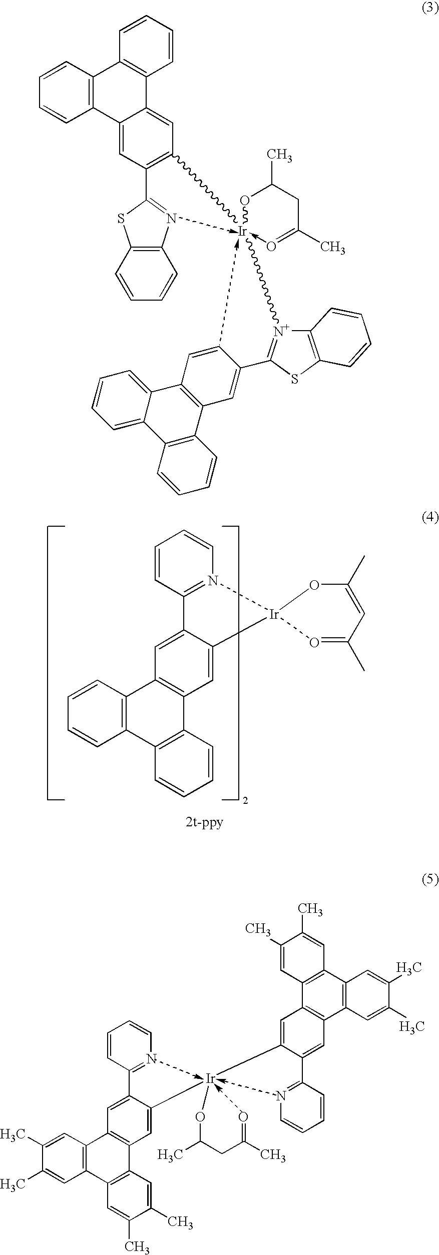

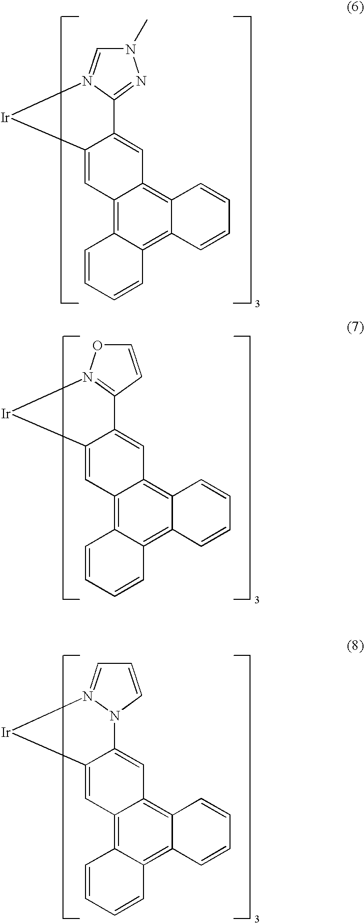

For a better build-up of such an electroluminescent device it is preferred that the electroluminescent compound is electrically neutral. This can e.g. be achieved in that charged ligands are used to compensate for the metal ion charges. By using a non-charged electroluminescent compound the electroluminescent compound can be deposited by vapor deposition.

Preferably, the thickness of the at least one layer of the electroluminescent compound is between >0 and ≦1000 Å, more preferably between ≧5 and ≦700 Å, more preferably between ≧20 and ≦500 Å, more preferably between ≧50 and ≦250 Å, and most preferably between ≧100 and ≦150 Å.

The concentration of electroluminescent complex compound present in the light-emitting layer of the OLED device is preferably between >0 and ≦100% (wt %), more preferably between ≧5 and ≦50% (wt %), more preferably between ≧10 and ≦30% (wt %), and most preferably between ≧11 and ≦25% (wt %).

A preferred OLED device according to the present invention comprises sequentially at least one first electrode, at least one layer of an electroluminescent compound as described above and at least one second electrode. As first and second electrode, all electrodes known in the art can be used.

A typical OLED layout can be used based on a multi-layer structure known in the art. On a glass substrate an anode layer that usually is made of ITO followed by a hole transporting layer and a light-emitting layer are placed. The light-emitting layer comprises the metal complex compound of the present invention embedded in a matrix that has good transport efficiencies for holes and electrons alike. A hole-blocking layer wherein the holes are difficult to be injected follows the light-emitting layer. On top of this layer an electron transport layer is located which thickness is measured to minimize quenching of the emission by the following metallic cathode.

A preferred lighting unit according to the present invention contains an OLED device as described above and can be used in household applications, shop lighting, home lighting, accent lighting, spot lighting, theater lighting, fiber-optics applications, projection systems, self-lit displays, medical lighting applications, pixelated displays, segmented displays, warning signs, indicator signs, automotive lighting, decorative lighting, etc.

The present invention furthermore relates to the use of a metal transition metal complex having at least one tailored ligand having a general structure of

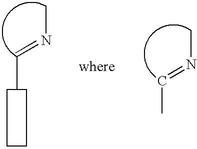

is a N-containing heterocycle comprising one or more cycle and where

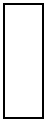

is a unit with a triplet energy of ≧22,220 cm⁻¹
for electroluminescent compounds, especially OLEDs.

According to a preferred embodiment of the present invention the ligand is based on a triphenylene or substituted triphenylene structure as shown in formula (2).

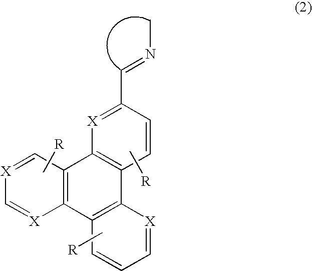

wherein each radical R is independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, silylalkyl, and/or silylalkyloxy,

and every X is independently selected out of C and N.

According to a preferred embodiment of the present invention the metal is a transition metal, preferably selected from the group comprising Ir, Rh, Ru, Pd, and Pt.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, features, characteristics and advantages of the object of the invention are disclosed in the subclaims, the figures and the following description of the respective figures and examples, which—in an exemplary fashion—show several preferred embodiments of a device according to the invention.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several preferred embodiments of a device as well as an OLED according to the invention.

FIG. 1 shows a current versus voltage diagram of the OLED according to example 1 described in table 1 below.

FIG. 2 shows a current efficiency [Cd/A] versus luminance [Cd/m²] diagram of the OLED device according to example 1.

FIG. 3 shows a power efficiency [lm/W] versus luminance [Cd/m²] diagram of the OLED device according to example 1.

FIG. 4 shows an electroluminescence spectrum of OLED device according to example 1 (see table 1 below).

FIG. 5 shows a current versus voltage diagram of the OLED device according to example 2 described in table 2 below.

FIG. 6 shows a current efficiency [Cd/A] versus luminance [Cd/m²] diagram of the OLED device according to example 2.

FIG. 7 shows a power efficiency [lm/W] versus luminance [Cd/m²] diagram of the OLED device according to example 2.

FIG. 8 shows an electroluminescence spectrum of OLED device according to example 2 (see table 2 below).

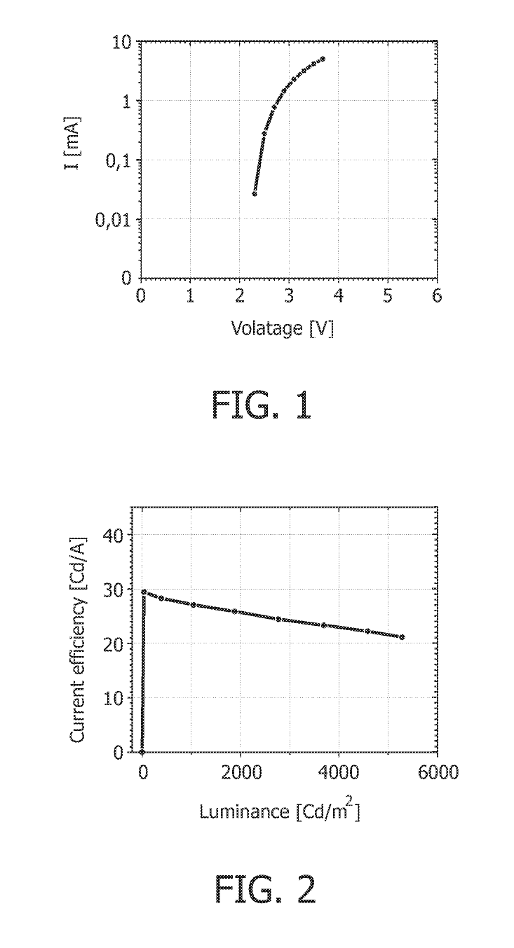

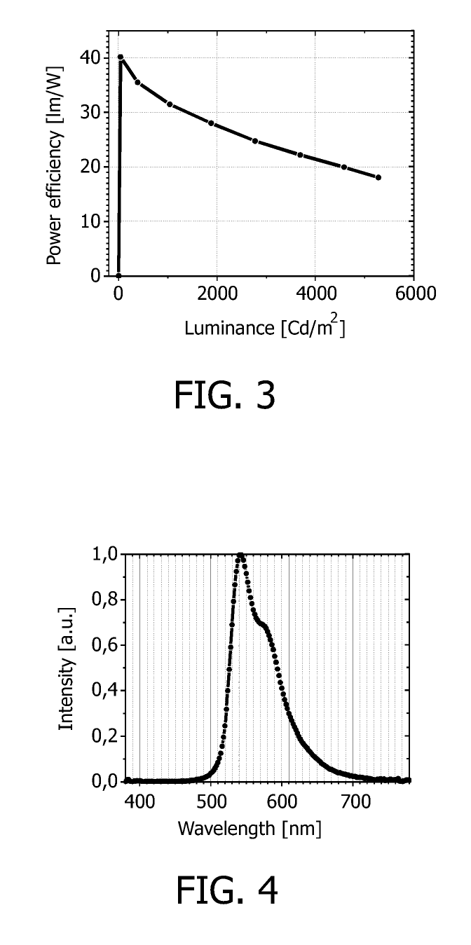

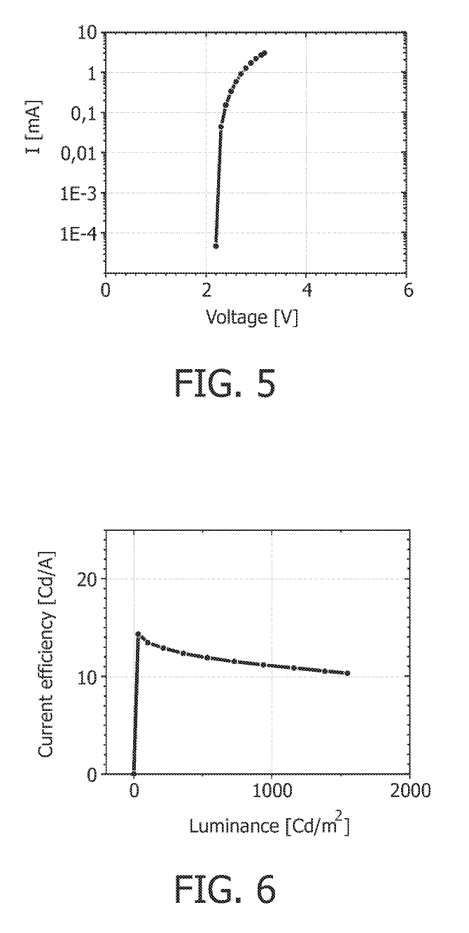

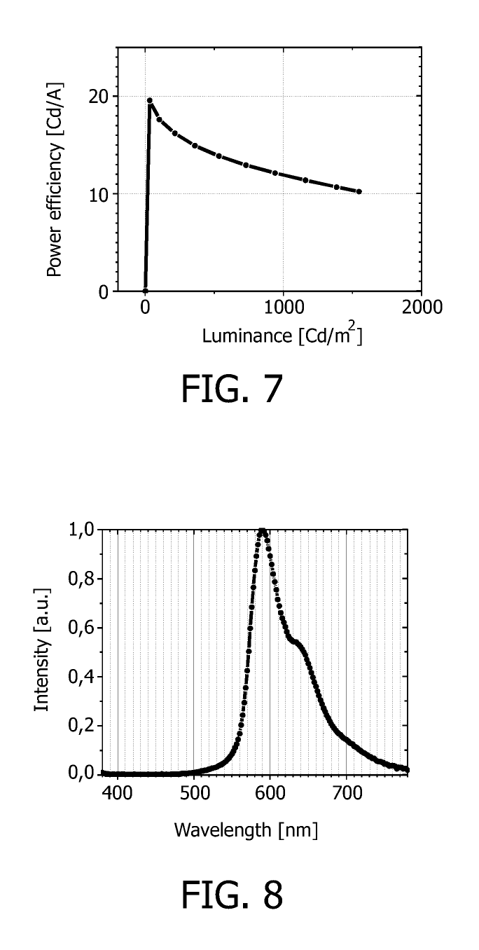

### DETAILED DESCRIPTION OF EMBODIMENTS

### Example 1

Emitter Ir(2t-ppy) is doped into a matrix consisting of n-MTDATA. The detailed structure of the OLED device is shown in the table below. The triplet energy of Ir(2t-ppy) is 18600 cm⁻¹.

TABLE 1
Layer structure OLED device according to example 1.

| Layer | Material | thickness | |
|---|---|---|---|
| Anode | ITO | 120 | nm |
| Hole injection layer | NHT1:NDP2 | 20 | nm |
| Hole transport layer | n-MTDATA | 10 | nm |
| Matrix:Emitter | n-MTDATA:Ir(2t- | 25 | nm |
| | ppy) 8 at % | | |
| Electron transport layer | TPBI | 10 | nm |
| Electron injection layer | NET5:NDN1 | 45 | nm |
| Cathode | Al | 100 | nm |

ITO = Indium tin oxide.
n-MTDATA = 4,4′,4″-Tris(N-(1-naphthyl)-
N-phenyl-amino)-triphenylamine
TPBI = 1,3,5-tris-(1-phenyl-1H-benzimidazol-2-yl)-benzene
NHT1, NDP2, NET5, NDN1 are products of Novaled GmbH Dresden.
NHT1:NDP2 is used to enhance inject of holes, and
NET5:NDN1 is used to enhance injection of
electrons into the OLED device.

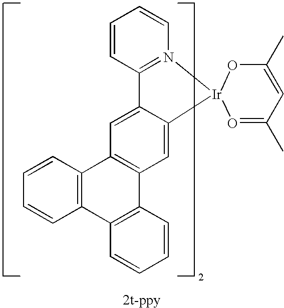

Formula 4: Structure of the emitter used in example 1.

The OLED device according to example 1 has at 1000 Cd/m² a current efficiency of 27.2 Cd/A, and a power efficiency is 32.1 μm/W.

### Example 2

Emitter Ir(2t-tiaz) is doped into a matrix consisting of n-MTDATA. The detailed structure is shown in the table below. The triplet energy of Ir(2t-tiaz) is 17000 cm⁻¹

TABLE 2
OLED structure according to example 2.

| Layer | Material | thickness | |
|---|---|---|---|
| Anode | ITO | 120 | nm |
| Hole injection layer | NHT1:NDP2 | 20 | nm |
| Hole transport layer | n-MTDATA | 10 | nm |
| Matrix:Emitter | n-MTDATA:Ir(2t- | 25 | nm |
| | tiaz) 8 at % | | |
| Electron transport layer | TPBI | 10 | nm |
| Electron injection layer | NET5:NDN1 | 45 | nm |
| Cathode | Al | 100 | nm |

ITO = Indium tin oxide
n-MTDATA = 4,4′,4″-Tris(N-(1-naphthyl)-N-
phenyl-amino)-triphenylamine
TPBI = 1,3,5-tris-(1-phenyl-1H-benzimidazol-2-yl)-benzene
NHT1, NDP2, NET5, NDN1 are products of Novaled GmbH Dresden.
NHT1:NDP2 is used to enhance inject of holes, and
NET5:NDN1 is used to enhance injection of
electrons into the OLED device.

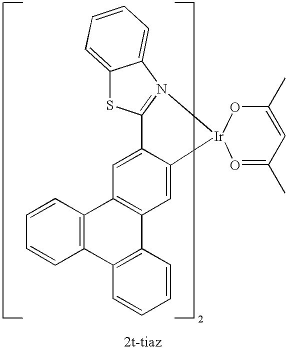

Formula 3: Structure of the emitter used in example 2.

The OLED device according to example 2 has at 1000 Cd/m² a current efficiency of 11.1 Cd/A, and a power efficiency of 11.9 lm/W.

### Example 3

Production of an inventive triphenylene derivative of the formula (IIb) according to Scheme 3:

### Synthesis of 2-Triphenylene carbonic acid

Step a)

Triphenylene (1 equivalent) is at 0° C. reacted with 2,1 equivalents AlCl3 and 21,0 equivalents CH3COCl in CH2Cl2. After 3 h stirring at room temperature the product (Acetyltriphenylene) is got in 97% yield, which is further reacted in Step b).

Step b)

The product of Step a) is reacted with mit 2,2 equivalents I2 (based on the raw yield of Acetyltriphenylene) in Pyridin solvent at room temperature. Then, the mixture is kept for 45 min under reflux, afterwards another portion I2 (1,0 equivalent) is added. After another hour at reflux NaOH, EtOH and water are added and the reaction mixture is heated to reflux for 2 h. 2-Triphenylene carbonic acid is got in 76% yield (based on the raw yield of Acetyltriphenylene and in 74% yield based on Triphenylene).

Production of a Triphenylene derivative according to formula IId

Step c)

1 equivalent 2-Triphenylene carbonic acid of step b) is reacted with PCl5 (2,1 equivalents) and 1,2 equivalents p-Toluolsulfonic acid amid in Xylol, where the temperature of the reaction is kept 17 h at 120° C. At 190° C. solvent and reagents are removed by distillation. After cooling to 5° C. Pyridin is added and work up with water is done. The product is obtained in 52% yield and is further reacted in step d).

Step d)

The product of step d) (1 equivalent) is reacted at 0° C. with gaseous HCl in Ethanol. The mixture is stirred for 24 hours at room temperature. The solvent is removed nearly completely. Afterwards ethanol as solvent, 1,3 equivalents MeNHNH2 and 2,5 equivalents NEt3 are added. The mixture is stirred for 24 hours at room temperature. At 0° C. the mixture is reduced to ¼, HCO2H is added and the EtOH is totally removed. Afterwards the triphenylene derivative of formula II d is obtained after addition of further HCO2H at room temperature and 2 hours reflux.

Production of a Triphenylene derivative according to formula IIe

Step e)

1 equivalent 2-Triphenylene carbonic acid of step b) is stirred with 2,0 equivalents BH3.THF in THF at room temperature for 16 hours. The reaction product is further reacted after work up with water in step f).

Step f)

The reaction product of step e) is reacted with MnO2 (25,0 equivalents, based on 2-Triphenylene carbonic acid) in CHCl3 as solvent for 3 days under reflux. The reaction product is further reacted after filtration over Celite in step g).

Step g)

The reaction product of step f) is stirred with 3,3 equivalents (based on 2-Triphenylene carbonic acid) H2NOH.HCl and 9,0 equivalents NaOH in EtOH for 1 hour at room temperature and for 30 min under reflux. The reaction product is obtained in 80-90% yield (2-Triphenylenealdoxim) and is further reacted in Schritt h) after work up with water.

Step h)

The reaction product of step g) is stirred with 1,0 equivalent (based on 2-Triphenylenealdoxim) NCS in CHCl3 for 30 min. Then, vinyl bromide (1,0 equivalent, based on 2-Triphenylenealdoxim) is added and NEt3 (1,1 equivalents) is added dropwise, where after 12 hours stirring at room temperature and work up with water the Triphenylene derivative of formula IIe is obtained. Alternatively to vinyl bromide vinyl acetate or phenylvinylselenide can be used, where at the use of vinyl acetate an additional reflux step is done before the work up, whereas in the use of vinylselenide the addition of 30% H2O2 at 0° C. before the work up is commended (in this case the reflux step is omitted).

### Example 4

### Production of an Inventive Triphenylene Derivative of the Formula (IIa) According to Scheme 4

Step a)

Triphenylene (1 equivalent) is reacted with 8 equivalents Br2 in the presence of catalytic amounts of iron in nitrobenzene, where 80% bromined Triphenylene derivative is obtained.

Step b)

The bromined triphenylene derivative (1 equivalent) afterwards is stirred with 5-10 mol-% CuI, 20 mol-% Amine (N,N-Dimethylcyclohexane-1,2-diamin or Phenantroline), 1,0 equivalent Pyrazole and 2,1 equivalents base (K2CO3, CsCO3 or NaOtBu) at 110° C. in Toluol for 24 hours.

Step c)

The reaction product of step b) afterwards is either reacted in step c1), in step c2) or in step c3) to get the triphenylene derivative of formula IIf:

c1) iPrMgCl.LiCl; HCl; c2) H2, NEt3, Pd(OH)2/C; c3) HCO2H, NEt3, P(oTol)3, Pd(OAc)2, DMF, 50° C., 24 h.

### Production of an Inventive Triphenylene Derivative of Formula (IIa) According to Scheme 5a

1-Trifluormethanesulfonato-2-trimethylsilylbenzene (3 equivalents) is reacted with 1 equivalent of the corresponding Iodine aryalte (see Scheme 5a), in the presence of 5 mol-% Pd(OAc)2, 5 mol-% dppf and 4 equivalents CsF in Toluol/Acetonitril, where the corresponding ligands of the formulae IId), IIe) or IIf) are obtained.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. OLED comprising as a luminescent compound in the light-emitting layer a metal complex having at least one tailored ligand having a general structure of 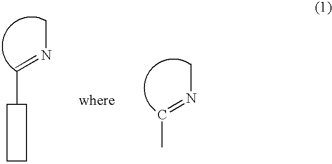
is a N-containing heterocycle comprising one or more cycle and where 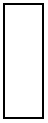
is a unit with a triplet energy of ≧22,220 cm⁻¹.

2. OLED according to claim 1 wherein the ligand (1) has a combined triplet energy of ≧16,000 cm⁻¹.

3. OLED according to claim 1 wherein the ligand (1) has a triplet energy between ≧16,000 cm⁻¹ and 19,500 cm⁻¹.

4. OLED according to claim 1, wherein the ligand is based on a triphenylene or substituted triphenylene structure as shown in formula (2). 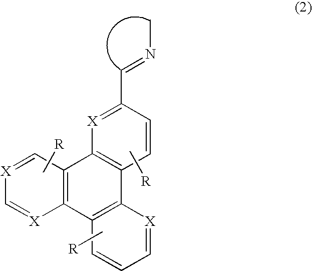
wherein each radical R is independently selected out of a group comprising hydrogen, hydroxyl, halogen, pseudohalogen, formyl, carboxyl and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether, silylalkyl, and/or silylalkyloxy,
where every X is independently C or N, and where 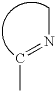
is a N-containing heterocycle comprising one or more cycle.

5. OLED according to claim 1 wherein the N-heterocycle unit is a pyridyl- or benzothiazyl-cycle or a triazolyl-, an isoxazolyl- or a pyrazolyl-cycle, which can be substituted or not substituted.

6. OLED according to claim 1 wherein the metal is a transition metal, preferably selected from the group comprising Ir, Rh, Ru, Pd, and Pt.

7. OLED according to claim 1 wherein the concentration of electroluminescent complex compound present in the light-emitting layer of the OLED device is preferably between >0 and ≦100% (wt %), more preferably between ≧5 and ≦50% (wt %), more preferably between ≧10 and ≦30% (wt %), and most preferably between ≧1 and ≦25% (wt %).

8-12. (canceled)
